(19) United States
(12) Patent Application Publication
(10) Pub. No.: US 2006/0103150 A1
(43) Pub. Date: May 18, 2006

(54) Bottle contaminant remover

(76) Inventor: Patricia A. Leonard, Warren, MI (US)

Correspondence Address: GREGORY T. ZALECKI, 12900 HALL ROAD, SUITE 400, STERLING HEIGHTS, MI, 48313, US

(21) Appl. No.: 10/988,037

(22) Filed: Nov. 12, 2004

(51) Int. Cl. B25J 1/04

(52) U.S. Cl. 294/26

(57) ABSTRACT

A bottle contaminant remover comprising a curved shank, an extension member and a hook member. The extension member extends from one end of the curved shank at an obtuse angle. A hook member extends from the extension member at an acute angle. The distance between the extension member—hook member junction and the end of the hook member is less than the diameter of the bottle opening of the bottle containing the contaminant. The shank, the extension member and the hook member form a cup like structure for grasping the bottle contaminant. A handle is attached to the shank to permit a user to hold the device and to apply finger pressure to the shank. To use the device it is inserted into a bottle. The contaminant is grasped. The device and the contaminant are then removed from the bottle.

### BACKGROUND

Beverages manufactured, sold and consumed in bottles are a common commodity. Bottled soda pop is one of the most common of all. Typically, the bottles have a narrow neck with a circular opening. Many bottles are intended to be returnable. They may be returnable because of an effort to protect the environment from litter caused by the disposal of empty bottles. They may also be returnable for reuse by a beverage manufacturer.

Solid contaminants often enter the interior of a bottle. For example, many beverage drinkers squeeze lime wedges into their beverage bottles to produce an enhanced beverage flavor. This creates a problem because the lime wedges expand upon entry into the bottle and will not fall out when the bottle is turned upside down after the beverage is consumed. The removal of lime wedges from beverage bottles is a difficult task. If the lime wedge is left inside of the bottle it quickly becomes moldy, unsightly and odorous. Other solid contaminants are also placed within bottles and become difficult to remove. These include garbage such as loose paper and cigarette butts.

It is desirable to remove solid contaminants from bottles. Some people are concerned about cleanliness and do not want to return bottles containing solid contaminants. Bottle return processors need to remove solid contaminants from bottles before the bottles are reused or otherwise recycled. This creates a problem because many solid contaminants are not easily removable from bottles. The contaminants are too large to fall out by gravity when the bottle is turned upside down. Additionally, it is difficult to grasp solid contaminants such as lime wedges located inside of bottles with common household tools such as table knives. Those tools do not have the capability of securely grasping the contaminant.

There is a need for a simple tool capable of reliably grasping a contaminant, such as a lime wedge, from within a bottle and facilitating the removal of the contaminant.

### SUMMARY

The bottle contaminant remover described herein satisfies this need. The bottle contaminant remover is comprised of a curved shank, an extension member and a hook member. The curve of the curved shank is defined by a radius. The radius need not be constant throughout the curve. In other words, the curve of the curved shank is not required to be in the shape of the circumference of the circle. The radius also facilitates the identification of sides of the curved shank. There is a side of the curved shank defined by the radius. There is a side of the curved shank which is opposite the curve defined by the radius of the shank. The preferred linear length of the curved shank is 16.25 cm. The linear length of the curved shank is the linear distance between each end of the curved shank.

The extension member extends from one end of the curved shank. It extends at an obtuse angle. The obtuse angle is defined on the side of the shank which is opposite to the circular curve defined by the radius of the shank. The shank and the extension member intersect at a distal vertex point. The distal vertex point is located on the periphery of the shank and the extension member junction which is opposite the obtuse angle.

Preferably, the obtuse angle between the extension member and the curved shank is between 130 degrees and 145 degrees. More preferably, the obtuse angle between the extension member and the curved shank is approximately 140 degrees.

The hook member extends at one end from the extension member at an acute angle. The acute angle is defined on the side of the curved shank which is opposite the curve defined by the radius of the shank. The periphery of the hook member has a distal end point at its other end. The distal end point of the hook member is distal to the obtuse angle. Thus the distal end point of the hook member is the point on the periphery of the hook member which is furthest from the distal vertex point of the curved shank and the extension member. Bottles upon which the bottle contaminant remover is intended to be used typically have small neck circular openings. The distance between the distal vertex point of the shank and extension member and the distal end point of the hook member is less than the diameter of the bottle opening. If the bottle opening is not circular the described distance must be less than the largest dimension of the opening. When the term diameter of the bottle opening is used within this specification it is intended to include the largest dimension of an opening of a bottle having a non circular opening.

Preferably, the acute angle between the hook member and the extension member is between 75 degrees and 85 degrees. More preferably, the acute angle between the hook member and the extension member is approximately 80 degrees. The preferred distance between the distal vertex point of the shank and extension member and the distal end point of the hook member is approximately 2.0 cm. It is also preferred that the end of the hook member having the distal end point be blunt.

Optionally, a handle is attached to the end of the curved shank opposite the extension member. The handle is shaped to fit within the palm of a user such that a user holding the handle within the palm of the user may apply pressure with the user's index finger to the curved shank.

Another version of the invention is a process for removing a contaminant from a bottle having a narrow neck opening. The process comprises selecting a bottle contaminant remover, as described; inserting the end of the bottle contaminant remover having the extension member and the hook member into the opening of the bottle; grasping the contaminant with the hook member; and removing the contaminant from the bottle by removing the bottle contaminant remover grasping the contaminant from the bottle.

### DRAWINGS

These and other features, aspects, and advantages of the present invention will become better understood with regard to the following description, appended claims, and accompanying drawings where:

FIG. 1 is a perspective view of a bottle contaminant remover in the process of removing a lime wedge from a bottle having a narrow neck opening.

FIG. 2 is a top plan view of the bottle contaminant remover of FIG. 1.

FIG. 3 is a detail top plan view of a portion of the curved shank, the extension member and the hook member of the bottle contaminant remover of FIG. 1.

FIG. 4 is a detail top plan view of a portion of the curved shank, the extension member and the hook member of the bottle contaminant remover of FIG. 1, showing the insertion of the extension member and the hook member into the narrow neck opening of the bottle of FIG. 1.

### DESCRIPTION

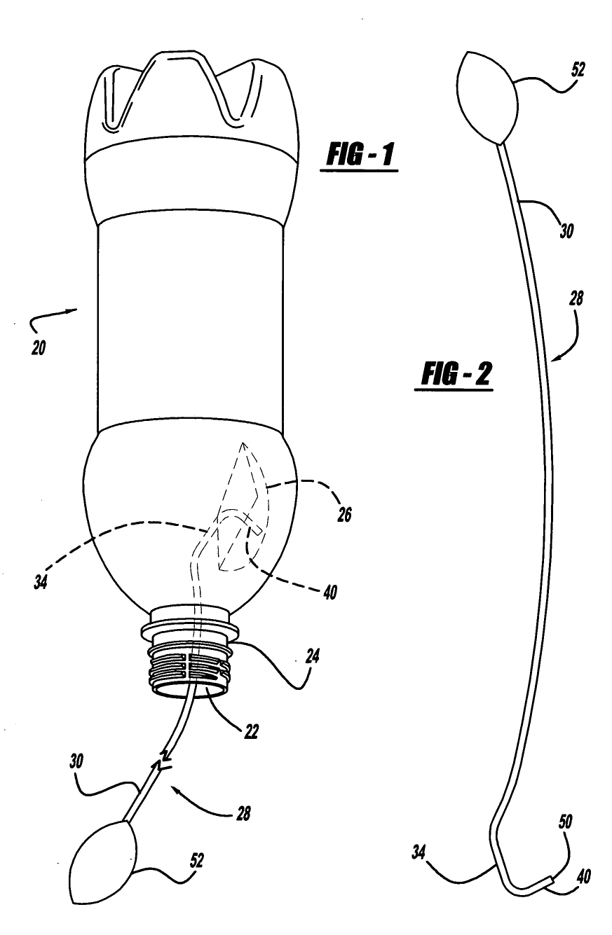

FIG. 1 shows a bottle contaminant remover 28 being used to remove a contaminant 26 from a bottle 20. The contaminant 26 is a lime wedge. The bottle 20 is a typical soda pop bottle. The bottle 20 has a narrow neck 24 with an opening 22.

FIG. 2 is a top plan view of the bottle contaminant remover 28 which is shown in FIG. 1. The preferred embodiment of the bottle contaminant remover 28 is shown in FIG. 2. The bottle contaminant remover 28 is comprised of a curved shank 30, an extension member 34, a hook member 40 and a handle 52. The handle 52 is optional.

The curved shank 30, the extension member 34 and the hook member 40 are preferably formed from a small diameter steel rod such as is used to form common coat hangers. The steel rod is bent into the shape described herein. The shank 30, extension member 34 and hook member 40 may also be molded from plastic. The plastic version may also include an integral molded handle 52.

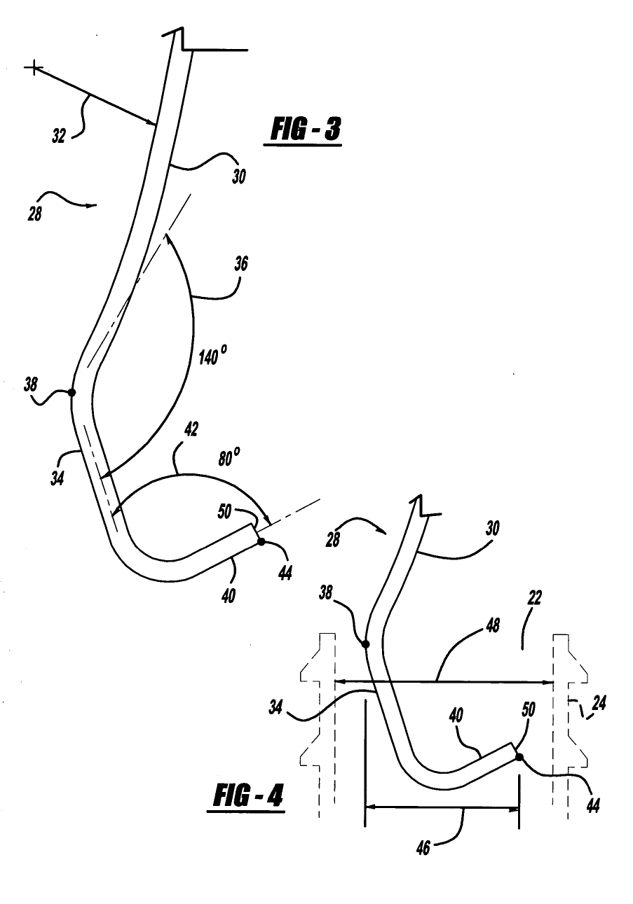

The curve of the curved shank 30 is defined by a radius 32. The radius 32 need not be uniform along the periphery of the curved shank 30. If the radius 32 is constant along the periphery of the curved shank 30, the curved shank 30 will be in the form of the circumference of a circle, otherwise, the curve will be non circular. The radius 32 also assists in identifying sides of the curved shank 30. One side of the curved shank 30 is the side where the curve is defined by the radius 32. Another side of the curved shank 30 is the side of the shank 30 opposite the curve defined by the radius 32. This side is shown as the side of the curved shank 30 defining in part the angle 36 between the curved shank 30 and the extension member 34 in FIG. 3.

The curved shank 30 has two ends. The linear length between these two ends of the curved shank 30 is preferably 16.25 cm.

The extension member 34 extends from one end of the curved shank 30 at an obtuse angle 36. As used herein, the term obtuse angle means an angle greater than 90 degrees and less than 180 degrees. The obtuse angle 36 between the curved shank 30 and the extension member 34 is defined on the side of the shank 30 opposite the curve defined by the radius 32 of the shank 30. As shown in FIG. 3, the obtuse angle 36 between the curved shank 30 and the extension member 34 should be measured between the centerline of the curved shank 30 and the centerline of the extension member 34 at the junction of the curved shank 30 and the extension member 34. The shank 30 and the extension member 34 intersect at a distal vertex point 38 on the periphery of the shank 30 and the extension member 34 junction, as shown in FIG. 3. The distal vertex point 38 is defined on a point of the periphery of the shank 30 and extension member 34 junction which is opposite the obtuse angle 36, as shown in FIG. 3.

The obtuse angle 36 between the extension member 34 and the curved shank 30 is between 130 degrees and 145 degrees. Preferably, it is approximately 140 degrees.

The hook member 40 extends at one end from the extension member 34 at an acute angle 42. As used herein, the term acute angle means an angle less than 90 degrees and more than 0 degrees. The acute angle 42 between the hook member 40 and the extension member 34 is defined on the side of the shank 30 opposite the curve defined by the radius 32 of the shank 30. As shown in FIG. 3, the acute angle 42 between the extension member 34 and the hook member 40 should be measured between the centerline of the extension member 34 and the centerline of the hook member 42 at the junction of the extension member 34 and the hook member 42.

The acute angle 42 between the hook member 40 and the extension member 34 is between 75 degrees and 85 degrees. Preferably, it is approximately 80 degrees.

The periphery of the hook member 40 has a distal end point 44 at its other end. This is the end of the hook member 40 which is not attached to the extension member 34. The distal end point 44 is distal to the obtuse angle 36 between the curved shank 30 and the extension member 34. Thus the distal end point 44 is the point on the hook member 40 which is furthest from the distal vertex point 38 at the junction of the curved shank 30 and the extension member 34, as shown in FIG. 3.

The distance between the distal vertex point 38 of the shank 30 and extension member 34 and the distal end point 44 of the hook member 40 is less than the diameter of the bottle opening 22. This permits the shank 30, the extension member 34 and the hook member 40 to fit within the bottle opening 22. If the bottle opening 22 is not circular, the described distance must be less than the largest dimension of the opening 22. When the term diameter of the bottle opening 22 is used within this specification it is intended to include the largest dimension of an opening 22 of a bottle 20 having a non circular opening. Preferably the distance between the distal vertex point 38 of the shank 30 and extension member 34 and the distal end point 44 of the hook member 40 is 2.0 cm. This permits the shank 30, the extension member 34 and the hook member 40 to fit within the opening 22 of a standard sized soda pop bottle 20.

FIG. 4 demonstrates how the shank 30, the extension member 34 and the hook member 40 fit within the opening 22 of a bottle 20 having a circular opening 22. The bottle 20 has a narrow neck 24. The narrow neck 24 has an opening 22 with a fixed diameter 48. The distance 46 between the distal vertex point 38 and the distal end point 42 is less than the diameter 48 of the bottle opening 22 in order to permit the curved shank 30, the extension member 34 and the hook member 40 to enter the opening 22.

Preferably, the end of the hook member 40 having the distal end point 38 is blunt 50. This minimizes the possibility of a puncture injury caused by the hook member 40 to a user of the bottle contaminant remover 28. It also facilitates the grasping of a contaminant 26 within the cup like structure formed by the hook member 40, the extension member 34 and the curved shank 30, when it is desirable to so grasp the contaminant 26, rather than having the contaminant 26 pierced by the hook member 40.

Preferably, a handle 52 is attached to the free end of the curved shank 30. This is the end of the curved shank 30 which is not attached to the extension member 34. The handle 52 is shaped to fit within the palm of a user. The handle 52 is also shaped such that a user holding the handle 52 within the palm of a user may apply pressure with the user's index finger to the curved shank 30.

Another version of the invention is a process for removing a contaminant 26 from a bottle 20 having a narrow neck 24 opening 22. This process is shown, in part, in FIG. 1. The contaminant 26 within the bottle 20 is a lime wedge. The first step of the process is to select a bottle contaminant remover 28, as described above. The bottle 20 is turned upside down as shown in FIG. 1. The end of the bottle contaminant remover 28 having the extension member 34 and the hook member 40 is inserted into the opening 22 of the bottle 20, as shown in FIG. 4. The lime wedge contaminant 26 is grasped with the hook member 40, as shown in FIG. 1. The cup like structure formed by the hook member 40, the extension member 34 and the curved shank 30 is used to grasp the contaminant 26. The curved nature of the curved shank 30 facilitates the entry of the bottle contaminant remover 28 into the bottle 20, as well as the grasping of the contaminant 26. During the grasping process index finger pressure is applied to the curved shank 30. The ability of the user to apply pressure to the curved shank 30 and grasp the contaminant 26 is enhanced because of the fit between the curved shank 30 and the curved internal contours of the bottle 20. The last step of the process for removing a contaminant 26 from a bottle 20 having a narrow neck 24 opening is removing the contaminant 26 from the bottle 20 by removing the bottle contaminant remover 28, which is grasping the contaminant 26, from the bottle 20.

The bottle contaminant remover 28 as described herein and the process for removing a contaminant 26 from a bottle 20 having a narrow neck 24 opening 22 facilitate quicker, cleaner and easier removal of contaminants 26 from bottles 20.

Although the invention has been shown and described with reference to certain preferred embodiments, those skilled in the art undoubtedly will find alternative embodiments obvious after reading this disclosure. With this in mind, the following claims are intended to define the scope of protection to be afforded the inventor, and those claims shall be deemed to include equivalent constructions insofar as they do not depart from the spirit and scope of the present invention.

What is claimed is:

1. A bottle contaminant remover comprising:
(a) a curved shank wherein the curve of said curved shank is defined by a radius;
(b) an extension member extending from one end of the curved shank at an obtuse angle, said obtuse angle being defined on the side of the shank opposite the curve defined by the radius of the shank, said shank and said extension member intersecting at a distal vertex point on the periphery of the shank and extension member junction which is opposite the obtuse angle; and
(c) a hook member extending at one end from the extension member at an acute angle defined on the side of the shank opposite the curve defined by the radius of the shank, the periphery of said hook member having a distal end point at its other end which is distal to the obtuse angle, wherein the distance between the distal vertex point of the shank and extension member and the distal end point of the hook member is less than the diameter of the bottle opening.

2. The bottle contaminant remover of claim 1 wherein:
(a) the obtuse angle between the extension member and the curved shank is between 130 degrees and 145 degrees, and
(b) the acute angle between the hook member and the extension member is between 75 degrees and 85 degrees.

3. The bottle contaminant remover of claim 1 wherein:
(a) the obtuse angle between the extension member and the curved shank is approximately 140 degrees, and
(b) the acute angle between the hook member and the extension member is approximately 80 degrees.

4. The bottle contaminant remover of claim 1 wherein the end of the hook member having the distal end point is blunt.

5. The bottle contaminant remover of claim 2 wherein the end of the hook member having the distal end point is blunt.

6. The bottle contaminant remover of claim 3 wherein the end of the hook member having the distal end point is blunt.

7. The bottle contaminant remover of claim 3 wherein the linear length of the shank is approximately 16.25 cm and the distance between the distal vertex point of the shank and extension member and the distal end point of the hook member is approximately 2.0 cm.

8. A bottle contaminant remover comprising:
(a) a curved shank wherein the curve of said curved shank is defined by a radius;
(b) an extension member extending from one end of the curved shank at an obtuse angle, said obtuse angle being defined on the side of the shank opposite the curve defined by the radius of the shank, said shank and said extension member intersecting at a distal vertex point on the periphery of the shank and extension member junction which is opposite the obtuse angle;
(c) a hook member extending at one end from the extension member at an acute angle defined on the side of the shank opposite the curve defined by the radius of the shank, the periphery of said hook member having a distal end point at its other end which is distal to the obtuse angle, wherein the distance between the distal vertex point of the shank and extension member and the distal end point of the hook member is less than the diameter of the bottle opening; and
(d) a handle shaped to fit within the palm of a user attached to the other end of the curved shank such that a user holding the handle within the palm of the user may apply pressure with the user's index finger to the curved shank.

9. The bottle contaminant remover of claim 8 wherein:
(a) the obtuse angle between the extension member and the curved shank is between 130 degrees and 145 degrees, and
(b) the acute angle between the hook member and the extension member is between 75 degrees and 85 degrees.

10. The bottle contaminant remover of claim 8 wherein:
(a) the obtuse angle between the extension member and the curved shank is approximately 140 degrees, and
(b) the acute angle between the hook member and the extension member is approximately 80 degrees.

11. The bottle contaminant remover of claim 8 wherein the end of the hook member having the distal end point is blunt.

12. The bottle contaminant remover of claim 9 wherein the end of the hook member having the distal end point is blunt.

13. The bottle contaminant remover of claim 10 wherein the end of the hook member having the distal end point is blunt.

14. The bottle contaminant remover of claim 10 wherein the linear length of the shank is approximately 16.25 cm and the distance between the distal vertex point of the shank and extension member and the distal end point of the hook member is approximately 2.0 cm.

15. A process for removing a contaminant from a bottle having a narrow neck opening, said process comprising:
(a) selecting a bottle contaminant remover comprising:
(i) a curved shank wherein the curve of said curved shank is defined by a radius;
(ii) an extension member extending from one end of the curved shank at an obtuse angle, said obtuse angle being defined on the side of the shank opposite the curve defined by the radius of the shank, said shank and said extension member intersecting at a distal vertex point on the periphery of the shank and extension member junction which is opposite the obtuse angle; and
(iii) a hook member extending at one end from the extension member at an acute angle defined on the side of the shank opposite the curve defined by the radius of the shank, the periphery of said hook member having a distal end point at its other end which is distal to the obtuse angle, wherein the distance between the distal vertex point of the shank and extension member and the distal end point of the hook member is less than the diameter of the bottle opening;
(b) inserting the end of the bottle contaminant remover having the extension member and the hook member into the opening of the bottle;
(c) grasping the contaminant with the hook member; and
(d) removing the contaminant from the bottle by removing the bottle contaminant remover, which is grasping the contaminant, from the bottle.

16. The process for removing a contaminant from a bottle having a narrow neck opening of claim 15 wherein:
(a) the obtuse angle between the extension member and the curved shank is between 130 degrees and 145 degrees, and
(b) the acute angle between the hook member and the extension member is between 75 degrees and 85 degrees.

17. The process for removing a contaminant from a bottle having a narrow neck opening of claim 15 wherein:
(a) the obtuse angle between the extension member and the curved shank is approximately 140 degrees, and
(b) the acute angle between the hook member and the extension member is approximately 80 degrees.

18. The process for removing a contaminant from a bottle having a narrow neck opening of claim 15 wherein the end of the hook member having the distal end point is blunt.

19. The process for removing a contaminant from a bottle having a narrow neck opening of claim 16 wherein the end of the hook member having the distal end point is blunt.

20. The process for removing a contaminant from a bottle having a narrow neck opening of claim 17 wherein the end of the hook member having the distal end point is blunt.

21. The process for removing a contaminant from a bottle having a narrow neck opening of claim 17 wherein the linear length of the shank is approximately 16.25 cm and the distance between the distal vertex point of the shank and extension member and the distal end point of the hook member is approximately 2.0 cm.
